(19) United States
(12) Patent Application Publication
(10) Pub. No.: US 2016/0302121 A1
(43) Pub. Date: Oct. 13, 2016

(54) METHOD AND APPARATUS FOR TRANSMITTING IP PACKET USING SEGMENT ROUTING

(71) Applicant: ELECTRONICS AND TELECOMMUNICATIONS RESEARCH INSTITUTE, Daejeon (KR)

(72) Inventor: Jeong Yun KIM, Daejeon (KR)

(21) Appl. No.: 15/008,883

(22) Filed: Jan. 28, 2016

(30) Foreign Application Priority Data
Apr. 7, 2015 (KR) 10-2015-0049065

(51) Int. Cl. H04W 36/14

(52) U.S. Cl. CPC H04W 36/14

(57) ABSTRACT

There are provided a method and an apparatus for transmitting an IP packet using segment routing. A path controller for transmitting an IP packet in a mobile communication system including heterogeneous networks includes a data transmission path establishing module configured to, if a request message for establishing a data path is received from any one of a plurality of mobile nodes, determine transport nodes that the IP packets is traverse between mobile nodes, and transmit segment values corresponding to the determined transport nodes to the mobile nodes sending the request message for establishing the data path, wherein the plurality of mobile nodes are connected to transport nodes and there may be a lot of data paths between them.

### CROSS-REFERENCE TO RELATED APPLICATION

This application claims priority to and the benefit of Korean Patent Application No. 10-2015-0049065, filed on Apr. 7, 2015, in the Korean Intellectual Property Office, the entire contents of which are incorporated herein by reference in their entirety.

### BACKGROUND

1. Field

An aspect of the present disclosure relates to a method and an apparatus for transmitting an IP packet using segment routing.

2. Description of the Related Art

A mobile network includes mobile nodes for providing mobile services such as voice calls and Internet connection, and transmitting nodes for transmitting IP packets between an user equipment (UE) and a mobile node, and between the mobile nodes. In the case of long term evolution (LTE) access, examples of the mobile nodes are eNB, S-GW, P-GW, etc. In the case of wireless fidelity (WiFi) access, examples of the mobile nodes are AP/APC, ePDG, P-GW, etc. The transmitting nodes may be subdivided into a switch, an access router, and a core router. However, the transmitting node may be simply referred to as a router.

A handover refers to a process of transferring a call signal from one base station to another base station as a user moves out of coverage or as network software resets a call path. The handover refers to a function of converting a communication channel of a current cell into that of another cell to keep communication continued when a mobile station moves from the coverage of one base station (or sector) being serviced to the coverage of another base station (or sector).

Handover techniques between LIE and non-3GPP networks are proposed as current 3rd generation partnership project (3GPP) standards. According to a conventional handover technique between LIE and non-3GPP networks, a terminal immediately performs access to a target network without any advance preparation for a handover.

In particular, in a handover between WiFi and LTE networks, mobile nodes for WiFi and LTE services are located between a UE and a server, and set a connection between the UE and the server using a tunneling technique. In this state, the mobile nodes are located over a transport network and do not recognize the configuration of the underlay transport network and information on a selected transport path. Hence, the mobile nodes should select and establish a new transport path whenever a handover occurs. Therefore, a delay occurs due to making a new transport path as well as negotiating QoS among the candidated paths.

### SUMMARY

Embodiments provide a method and an apparatus for transmitting an IP packet, in which when a data path through which an IP packet is to be transmitted between mobile nodes is set in a mobile network, appropriate nodes performing relaying functions are specified by considering service characteristics and statuses of the network, and the IP packet is transmitted through the corresponding nodes, thereby setting the data path at high speed.

Embodiments also provide a method and an apparatus for transmitting an IP packet, in which a data path before a handover occurs is set to be used after the handover occurs, thereby reducing a delay caused by the handover.

According to an aspect of the present disclosure, there is provided a path controller for transmitting an IP packet in a mobile communication system including heterogeneous networks, the path controller including: a data transmission path establishing module configured to, when a request message for establishing a data path is received from any one of a plurality of mobile nodes, determine nodes that IP packets traverse between the plurality of the mobile nodes, and transmit a segment list or a set of segment list corresponding to the determined nodes that IP packets traverse to the mobile node sending the request message for establishing the data path, wherein the plurality of mobile nodes are connected to transport nodes that enable the IP packets to traverse between the plurality of the mobile nodes, a plurality of nodes that transmit the IP packets are provided between the transport nodes, and the data path is set by the determined nodes among the plurality of nodes.

According to an aspect of the present disclosure, there is provided a method for transmitting an IP packet in a mobile communication system including heterogeneous networks, the method including: (a) receiving a request message for establishing a data path from any one of a plurality of mobile nodes; (b) when the request message for establishing the data path is received, determining nodes that IP packets traverse between the plurality of the mobile nodes, wherein the plurality of mobile nodes are connected to transport nodes that enable the IP packets to traverse between the plurality of the mobile nodes, a plurality of nodes that transmit the IP packets are provided between the transport nodes, and the data path is set by the determined nodes among the plurality of nodes; and (c) transmitting a segment list or set of segment lists corresponding to the determined nodes to the mobile node transmitting the request message for establishment of the data path.

In addition, there are provided another method for implementing the present disclosure, another system, and a computer-readable recording medium recording a computer program for executing the method.

### BRIEF DESCRIPTION OF THE DRAWINGS

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the example embodiments to those skilled in the art.

In the drawing figures, dimensions may be exaggerated for clarity of illustration. It will be understood that when an element is referred to as being “between” two elements, it can be the only element between the two elements, or one or more intervening elements may also be present. Like reference numerals refer to like elements throughout.

FIGS. 1A and 1B are diagrams illustrating a mobile communication system including heterogeneous networks.

FIG. 2 is a diagram illustrating a network configuration in which mobile nodes are connected to transport nodes shown in FIGS. 1A and 1B.

FIG. 3 is a diagram illustrating a network configuration for representing interactions between mobile and transport nodes according to an embodiment of the present disclosure.

FIG. 4 is a diagram illustrating internal modules of a path controller according to an embodiment of the present disclosure.

FIG. 5 is a diagram exemplarily illustrating a data transmission path after a handover occurs according to an embodiment of the present disclosure.

FIG. 6 is a flowchart exemplarily illustrating processes performed in a mobile communication system according to an embodiment of the present disclosure.

FIG. 7 is a diagram exemplarily illustrating operations of transmitting an IP packet between mobile nodes according to the present disclosure.

FIG. 8 is a diagram illustrating operations of transmitting an IP packet in a long term evolution (LTE) network according to a prior art.

### DETAILED DESCRIPTION

The specific structural or functional description disclosed herein is merely illustrative for the purpose of describing embodiments according to the concept of the present disclosure. The embodiments according to the concept of the present disclosure can be implemented in various forms, and cannot be construed as limited to the embodiments set forth herein.

The embodiments according to the concept of the present disclosure can be variously modified and have various shapes. Thus, the embodiments are illustrated in the drawings and are intended to be described herein in detail. However, the embodiments according to the concept of the present disclosure are not construed as limited to specified disclosures, and include all changes, equivalents, or substitutes that do not depart from the spirit and technical scope of the present disclosure.

While terms such as “first” and “second” may be used to describe various components, such components must not be understood as being limited to the above terms. The above terms are used only to distinguish one component from another. For example, a first component may be referred to as a second component without departing from the scope of rights of the present disclosure, and likewise a second component may be referred to as a first component.

It will be understood that when an element is referred to as being “connected to” another element, it can be directly connected to the other element or intervening elements may also be present. In contrast, when an element is referred to as being “directly connected to” another element, no intervening elements are present. Meanwhile, other expressions describing relationships between components such as “˜between,” “immediately˜between” or “adjacent to ˜” and “directly adjacent to ˜” may be construed similarly.

The terms used in the present application are merely used to describe particular embodiments, and are not intended to limit the present disclosure. Singular forms in the present disclosure are intended to include the plural forms as well, unless the context clearly indicates otherwise. It will be further understood that terms such as “including” or “having,” etc., are intended to indicate the existence of the features, numbers, operations, actions, components, parts, or combinations thereof disclosed in the specification, and are not intended to preclude the possibility that one or more other features, numbers, operations, actions, components, parts, or combinations thereof may exist or may be added.

So far as not being differently defined, all terms used herein including technical or scientific terminologies have meanings that they are commonly understood by those skilled in the art to which the present disclosure pertains. The terms having the definitions as defined in the dictionary should be understood such that they have meanings consistent with the context of the related technique. So far as not being clearly defined in this application, terms should not be understood in an ideally or excessively formal way.

Hereinafter, exemplary embodiments of the present disclosure will be described in detail with reference to the accompanying drawings. In the drawings, like reference numerals denote like elements, and their overlapping descriptions will be omitted.

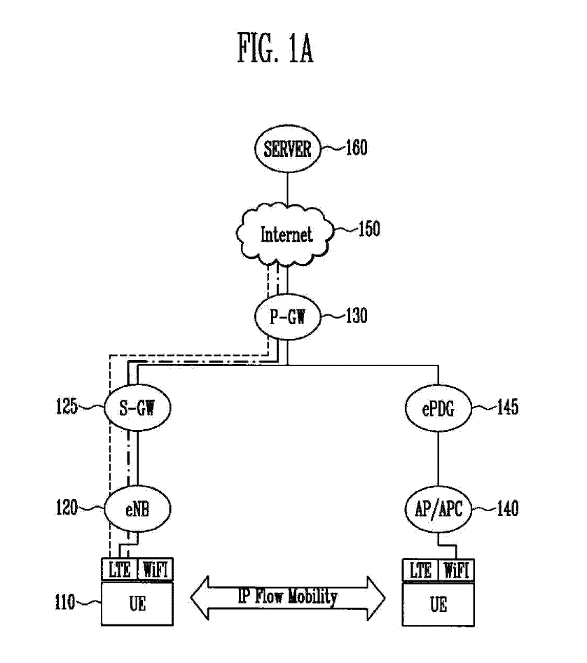

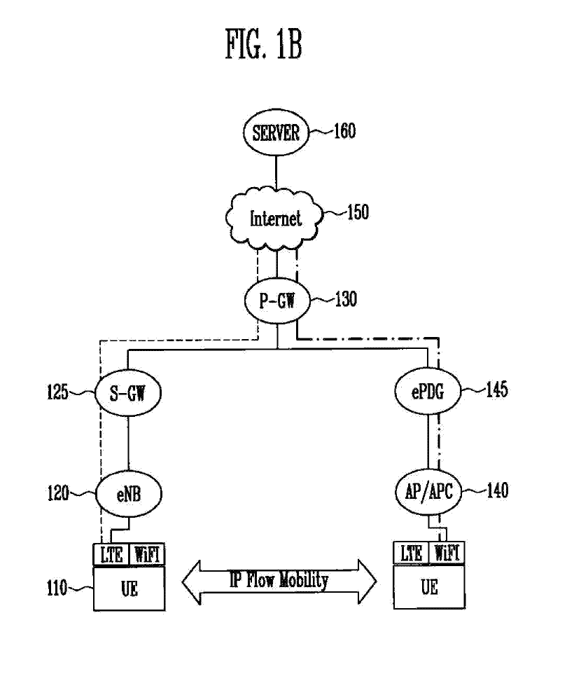

FIGS. 1A and 1B are diagrams illustrating a mobile communication system including heterogeneous networks.

As shown in FIGS. 1A and 1B, the mobile communication system 100 including heterogeneous networks includes a user equipment (UE) 110, a PDN-gateway (P-GW) 130, a serving gateway (S-GW) 125, an evolved node B (eNB) 120, an enhanced packet data gateway (ePDG) 145, an access point/access point controller (AP/APC) 140, and a server 160.

Hereinafter, the UE 110, the P-GW 130, the S-GW 125, the eNB 120, the ePDG 145, and the AP/APC 140 will all be referred to as mobile nodes.

First, the UE 110 according to the present disclosure is a digital device that includes a function capable of receiving a predetermined service provided from the server 160 by being connected to the eNB 120 or the AP/APC 140 and can use a plurality of network services including long term evolution (LTE), wireless fidelity (WiFi), etc. Any digital device such as a web pad or a smart phone may be employed as the UE 110 according to the present disclosure as long as it is equipped with a memory means and a microprocessor to have computing power.

Next, the server 160 according to the present disclosure may be an information providing equipment that can communicate with the UE 110 through the mobile communication system. The server 160 may be, for example, various web servers, and particularly, may be an operating server of an Internet portal site. The server 160 may provide the UE 110 with various contents and information related thereto through Internet 150.

Referring to FIG. 1A, when the UE 110 available for both an LTE network and a WiFi network uses a web browsing service (see a dashed-dotted line of FIG. 1A) and a moving image service (see a dotted line of FIG. 1A) through the LTE, the UE 110 receives data related to web browsing and moving images from the server 160 or transmits service request data to the server 160 through the P-GW 130, the S-GW 125, and the eNB 120.

After that, as shown in FIG. 1B, when the UE 110 receives the web browsing service provided through the WiFi network (see a dashed-dotted line of FIG. 1B) even though the UE 110 continuously receives the moving image service through the LTE network due to movement of the UE 110 to an area in which WiFi network services can be provided or another reason, i.e., when a handover is made from the LIE network to the WiFi network, the UE 110 receives data related to web browsing from the server 160 through the P-GW 130, the ePDG 145, and the AP/APC 140 or transmits data to the server 160. That is, as an access technique used by the UE 110 is changed due to the handover between heterogeneous networks, mobile nodes used by the UE 110 may also be changed.

In the UE 110 supporting two or more wireless signals, i.e., a dual mode in which it can receive services by being simultaneously connected to two or more access networks, sessions related to a specific service and services can be provided to the UE 110 while being freely moved between the access networks. Specifically, mobility and offloading are performed in terms of IP flows of a specific service, so that services can be flexibly provided. Thus, some IP traffics can pass through the LTE network, and the other IP traffics can pass through the WiFi network. For example, when a user recognizes the WiFi network during movement while simultaneously utilizing several flows such as a call function and a file download through a UE, the traffic used for the file download can be offloaded to a wireless local area network (WLAN), thereby reducing traffic congestion.

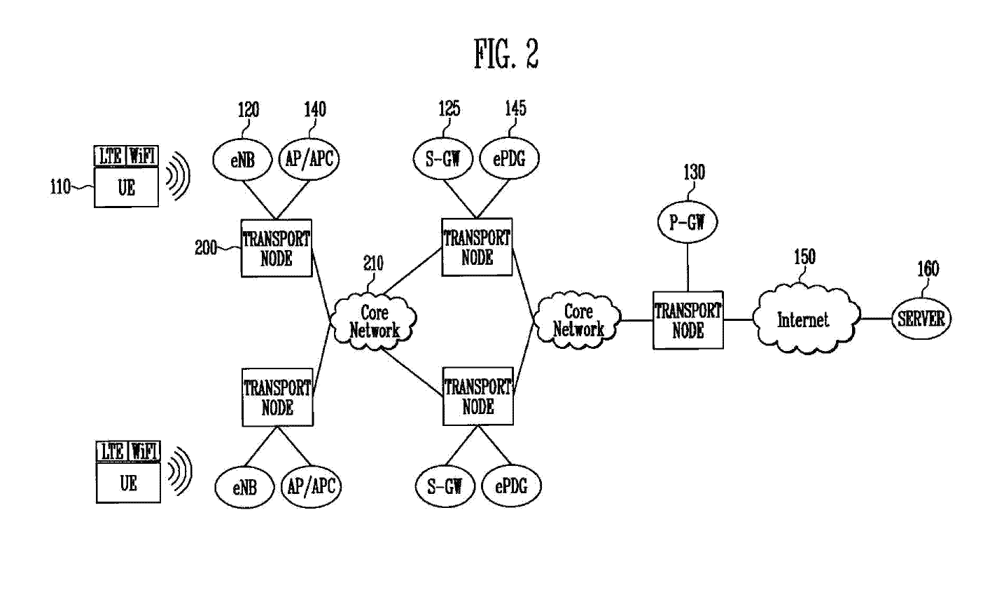

FIG. 2 is a diagram illustrating a network configuration in which mobile nodes are connected to transport nodes such as routers shown in FIGS. 1A and 1B.

As shown in FIG. 2, each of the mobile nodes in the mobile communication system may communicate via a router 200, but the present disclosure is not limited thereto.

More specifically, a plurality of routers may be provided such that the eNB 120 and the AP/APC 140 connected to a first router, the S-GW 125 and the ePDG 145 connected to a second router, and the P-GW 130 and the server 160 connected to a third router. The first and second routers may be connected to each other through a core network 210, and the second and third routers may be connected to each other through a core network 210.

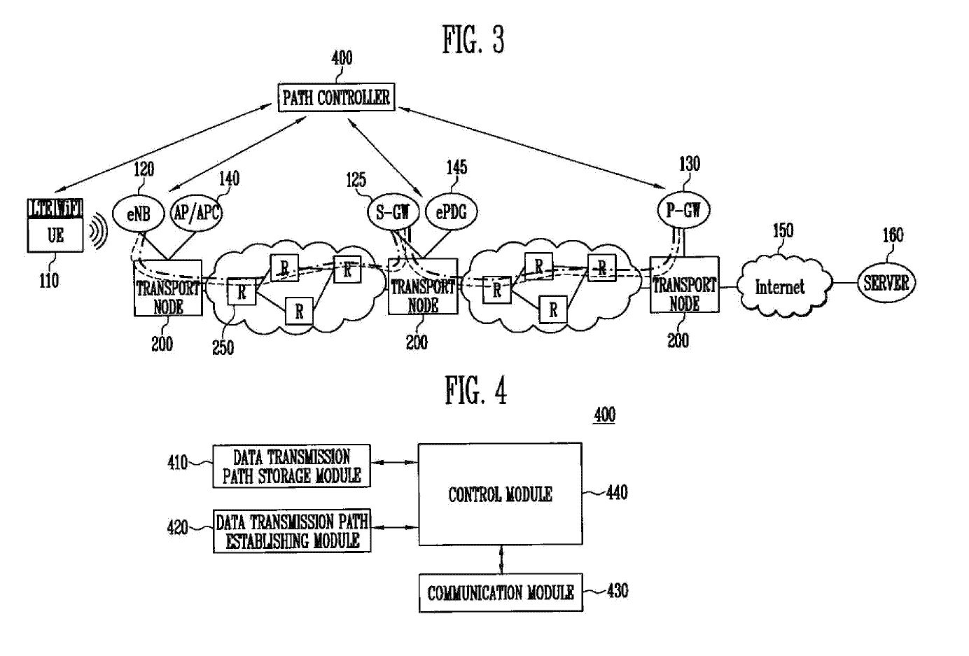

FIG. 3 is a diagram illustrating a network configuration of an entire system for representing interactions between mobile and transport nodes according to an embodiment of the present disclosure.

As shown in FIG. 3, the entire system according to the embodiment of the present disclosure may include a UE 110, an eNB 120, a S-GW 125, a P-GW 130, an AP/APC 140, an ePDG 145, routers 200, a plurality of mobile nodes 250 connecting between different routers, a path controller 400, Internet 150, and a server 160.

First, the UE 110, the eNB 120, the S-GW 125, the P-GW 130, the AP/APC 140, the ePDG 145, the routers 200, the Internet 150, and the server 160 have been described above, and therefore, their detailed descriptions will be omitted.

Next, if a request message for establishing a data path between two mobile nodes is received from an mobile node, the path controller 400 may determine transport nodes (routers) that IP packets traverse between transmitting sending mobile node and a receiving mobile node, and transmit, to the sending mobile, a segment list or a set of segment list corresponding to the transport nodes that IP packets traverse.

The configuration and functions of the path controller 400 according to the embodiment of the present disclosure will be described through the following detailed description.

Meanwhile, although not shown in this figure, the path controller 400 may communicate with mobile nodes through a communication network.

As shown in FIG. 3, when the UE 110 and the Internet 150 is connected to each other through the LTE network, a GPRS tunneling protocol (GTP) connection may be formed between the eNB 120 and the S-GW 125 and between the S-GW 125 and the P-GW 130. The GTP connection may be formed using any one of an equal cost multi-path (ECMP) routing scheme and a segment muting scheme. That is, according to the present disclosure, mobile nodes used to provide services through heterogeneous networks are connected to the same router, and an IP packet may be transmitted from any one mobile node to another mobile node along transport nodes forming a predetermined path.

Component of Path Controller

Hereinafter, an internal component of the path controller 400 and functions of the path controller 400 according to an embodiment of the present disclosure will be described.

FIG. 4 is a diagram illustrating an internal component of the path controller 400 according to an embodiment of the present disclosure.

As shown in FIG. 4, the path controller 400 according to the embodiment of the present disclosure may include a data transmission path storage module 410, a data transmission path establishing module 420, a communication module 430, and a control module 440. According to the embodiment of the present disclosure, at least one of the data transmission path storage module 410, the data transmission path establishing module 420, the communication module 430, and the control module 440 may be a program module that communicates with the UE 110, eNB 120, the S-GW 125, P-GW 130, the AP/APC 140, or the ePDG 145. The program module may be included in the path controller 400 in the form of an operating system, an application program module, or another program module, and physically, may be stored in various memory apparatuses known in the art. In addition, the program module may be stored in a remote memory apparatus communicable with the path controller 400. Meanwhile, the program module includes a routine, a subroutine, a program, an object, a component, a data structure, and the like, all of which either perform a particular task to be described below or implement a particular abstract data type according to the present disclosure. However, the program module is not limited thereto.

First, the data transmission path storage module 410 may perform a function of storing path information through which an IP packet is transmitted, more specifically, information on mobile nodes through which the IP packet passes, information on transport nodes connecting between the mobile nodes, the nodes through which the IP packet passes, information on segment values of the nodes, etc. On the contrary, it will be apparent to those skilled in the art that the data transmission path storage module 410 may also store information on an IP path through which a packet is transmitted from the Internet 150 to the UE 110.

This will be described in detail with reference to FIG. 3. If the UE 110 transmits an IP packet to the eNB 120 using an IP address of the Internet 150 as a destination in the LTE network, the eNB 120 transmits, to the S-GW 125, a packet obtained by adding an IP header (information that a destination is the S-GW 125) to the IP packet transmitted by the UE 110. Meanwhile, since mobile network including a plurality of transport nodes 250 exists between the eNB 120 and the S-GW 125, the IP packet can reach the S-GW 125 via the transport nodes forming a predetermined path.

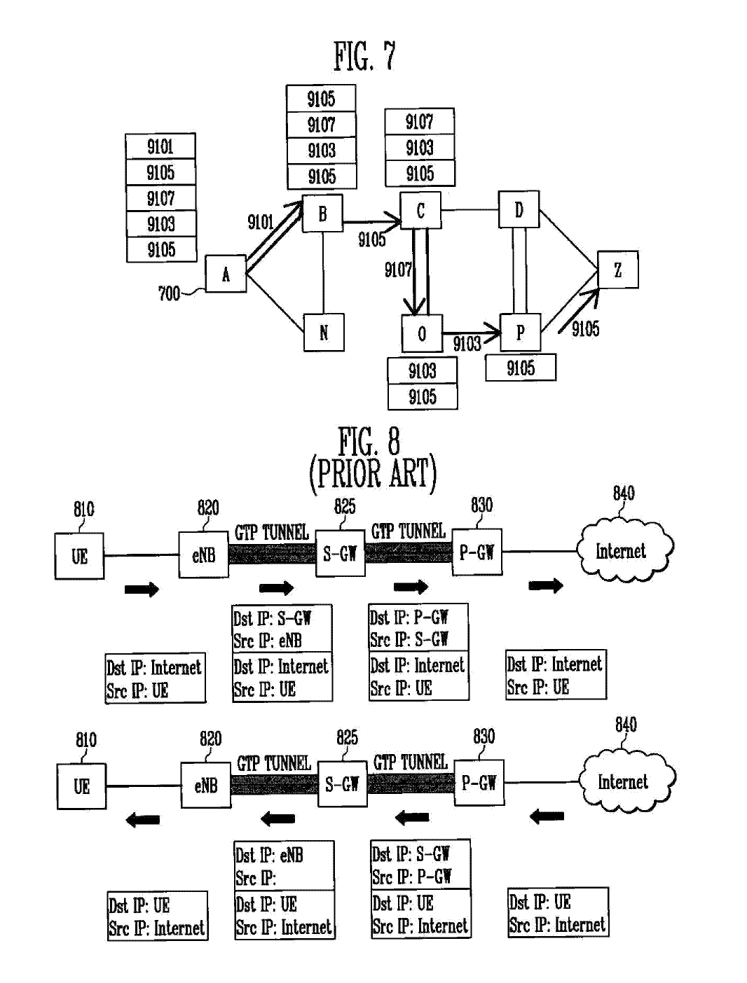

A process of transmitting an IP packet between mobile nodes, e.g., between the eNB 120 and the S-GW 125 will be described in detail with reference to FIG. 7.

FIG. 7 is a diagram exemplarily illustrating operations of transmitting an IP packet between mobile nodes according to the present disclosure.

Referring to FIG. 7, after a path from an origin to a destination is established before an IP packet is transmitted, information on the established path may be included in a packet header and then transmitted. In this case, an optimal path among a plurality of paths that may include a plurality of nodes 700 may be selected according to an operator's policy. For example, as shown in FIG. 7, node A may transmit an IP packet to node Z via nodes B, C, O, and P by adding path information to the IP packet before the node A transmits the IP packet. Here, 9101, 9105, 9107, 9103, and 9105 are segment values indicating nodes B, C, O, P, and Z, respectively.

According to the present disclosure, an IP packet can be transmitted from the eNB 120 to the S-GW 125 using the method described above.

Next, after the IP header is updated such that a destination IP address becomes the P-GW's 130, the S-GW 125 transmits the updated IP packet to the P-GW 130, and the P-GW 130 transmits, to the server 160, an IP packet that the UE 110 has transmitted to the eNB 120 as an IP packet from which an IP header is removed (see a dotted line of FIG. 3). Meanwhile, a transport network including a plurality of transport nodes also exists between the S-GW 125 and the P-GW 130, and thus an IP packet can be transmitted along a predetermined path including a plurality of nodes in the same manner that the IP packet is transmitted from the eNB 120 to the S-GW 125.

Next, if a request message for establishing a data path between a sending and a receiving mobile node is received from a mobile node, the data transmission path establishing module 420 may establish a path that IP packet traverse between mobile nodes through routers 200 such that the IP packet can be transmitted in the same manner as described above, and transmit, to the mobile node, a segment list of the ordered transport nodes that IP packet must traverse.

In this case, the data transmission path establishing module 420 may acquire IP addresses and port numbers of sending and receiving mobile nodes and 5-tuple information, and establish a data path that IP packets traverse with reference to the acquired information.

Meanwhile, when a message for establishing a data path is requested due to a handover, the data transmission path establishing module 420 may also acquire information on the related data path from the data transmission path storage module 410.

Specifically, when the UE 110 attached to the LTE network newly receives the web browsing service provided through the WiFi network due to movement of the UE 110 to an area in which WiFi network services are available or another reason, the data transmission path establishing module 420 receives, from the mobile nodes, a handover request message representing the request of a handover between heterogeneous networks.

After that, if the handover request message is received from the mobile nodes, the data transmission path establishing module 420 acquires information (segment values of the nodes) on the previous packet transmission path before the handover is requested from the data transmission path storage module 410, e.g., information on a packet transmission path in the LTE network as information on the path indicated by the dotted line of FIG. 3.

The data transmission path establishing module 420 may establish a new data path that the IP packets traverse between the different mobile nodes with reference to the packet transmission path before the handover is requested from the data transmission path storage unit 410. Particularly, although mobile nodes are changed due to the handover, data paths in the transport network connecting the mobile nodes to each other could be the same as those before the handover occurs.

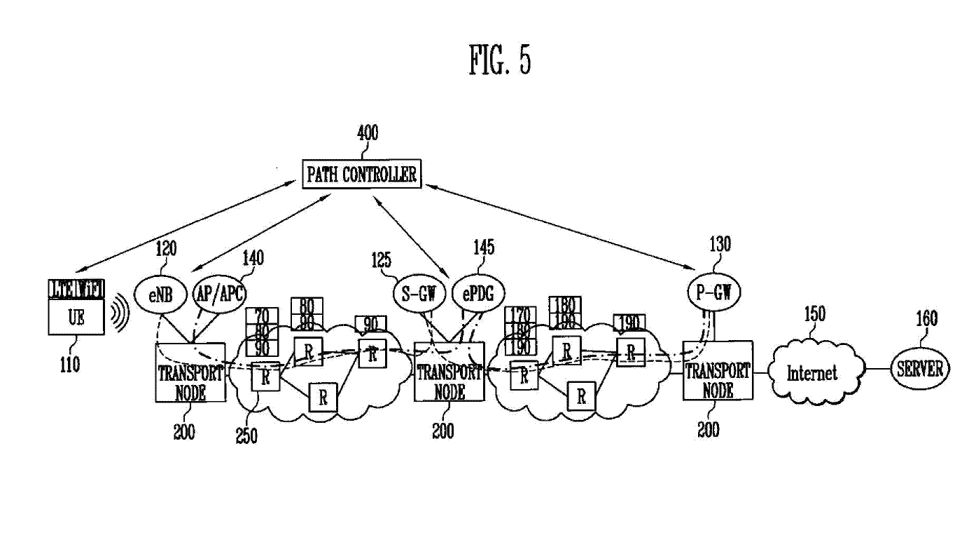

FIG. 5 is a diagram exemplarily illustrating a data transmission path after a handover occurs according to an embodiment of the present disclosure.

When assuming that a dashed-dotted line of FIG. 3 represents a data transmission path before a handover occurs, a dashed-dotted line of FIG. 5 may represent a data transmission path after the handover occurs. Referring to FIG. 5, as a handover is made from the LTE network to the WiFi network, mobile nodes that IP packets traverse are changed from ‘the eNB 120 <-> the S-GW 125 <-> the P-GW 130’ to ‘the AP/APC 140 <-> the ePDG 145 <-> the P-GW 130.’ However, as shown in FIG. 5, although the mobile nodes that the IP packets traverse are changed, the packet transmission path in the transport network connecting the mobile nodes to each other before the handover occurs may be the same as that after the handover occurs. The data transmission path establishing module 420 may transmit, to the AP/APC 140, the ePDG 145, or the P-GW 130, a segment list corresponding to the transport nodes used before the handover occurs.

FIG. 8 is a diagram illustrating operations of transmitting an IP packet in an LTE network according to a prior art.

In the conventional LTE network, the transmission and reception of data are performed using a GTP tunnel. When the GTP tunnel is used, an IP packet transmitted by a UE 810 is transmitted up to a P-GW 830 through an eNB 820 regardless of the IP address of a destination. Specifically, the eNB 820 adds a GTP header to the IP packet transmitted by the UE 810 in a section of the eNB 820—an S-GW 825. In this stage, the transmission-side IF address of the GTP header becomes the eNB's 820, and the reception-side IP address of the GTP header becomes the S-GW's 825. Next, the S-GW 825 removes the GTP header transmitted by the eNB 820 and adds its own GTP header to the IP packet in a section of the S-GW 825—the P-GW 830. In this stage, the transmission-side IP address of the GTP header becomes the S-GW's 825, and the reception-side IP address of the GTP header becomes the P-GW's 830. Finally, the P-GW 830 removes the GTP header and transmits the original IP packet generated by the UE 810 to the Internet 840 in a section of the P-GW 830—Internet 840. On the contrary, when an IP packet is transmitted from the Internet 840 to the P-GW 830, the IP packet is transmitted to the UE 810 via the GTP tunnel between the P-GW 830 and the S-GW 825 and the GTP tunnel between the S-GW 825 and the eNB 820. Meanwhile, although not separately shown in this figure, mobile nodes (an AP/APC and an ePDG) providing WiFi services may also be connected using a kind of tunneling techniques.

In the prior art, the mobile nodes are located over a transport network and do not recognize the configuration of the underlay transport network and information on a data path that IP packets traverse. Hence, the mobile nodes should repeatedly establish the data paths whenever a handover occurs. In addition, when mobile nodes providing different network services, e.g., mobile nodes providing LTE services are connected through predetermined transport nodes, and mobile nodes providing WiFi services are connected through different transport, it is highly likely that IP packets will be lost when a handover occurs.

On the other hand, according to the present disclosure, mobile nodes providing different network services, i.e., mobile nodes providing LTE services and mobile nodes providing WiFi services are connected to predetermined routers. When an IP packet is transmitted between the routers, the IP packet is controlled to be transmitted according to the above-described segment routing scheme. Thus, it is possible to effectively support IP flow mobility. Particularly, although a handover is made between the different mobile nodes, the existing data path is re-used, so that operations of re-establishing a data path can be omitted. Also, it is possible to significantly reduce a delay caused by the handover. In addition, it is possible to decrease the loss rate of data due to the handover.

Next, the communication module 430 may enable data transmission/reception of data to/from the data transmission path storage module 410 and the data transmission setting module 420.

Finally, the control module 440 may control the flow of data among the data transmission path storage module 410, the data transmission path establishing module 420, and the communication module 430. That is, the control module 440 may control the flow of data from/to the outside of the path controller 400 or the flow of data between the components of the path controller 400, to control each of the data transmission path storage module 410, the data transmission path establishing module 420, and the communication module 430 to perform its proper function.

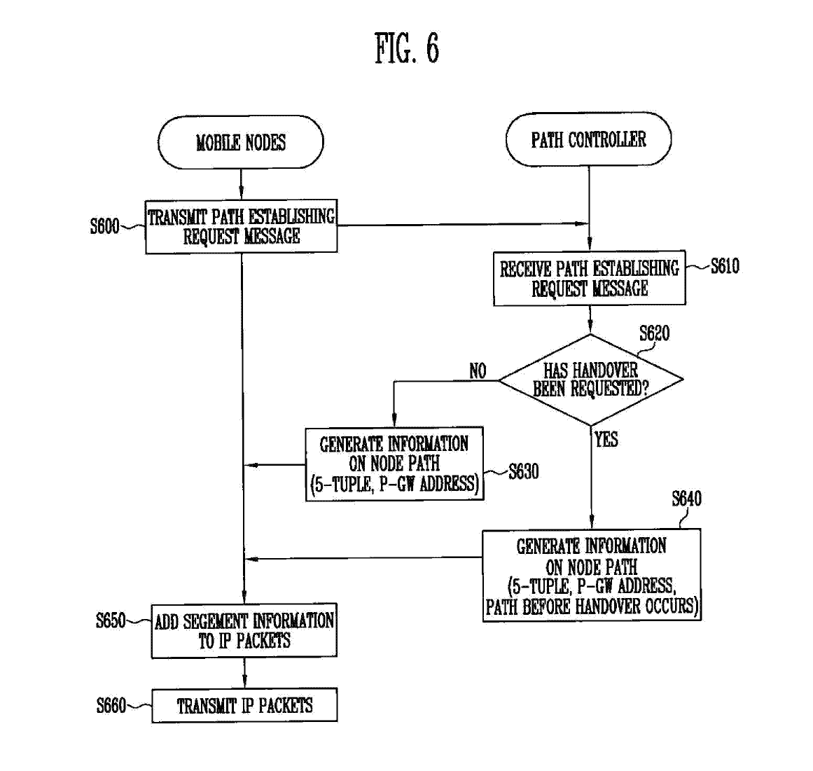

FIG. 6 is a flowchart exemplarily illustrating processes performed in a mobile communication system according to an embodiment of the present disclosure.

In step 600, a mobile node may send a message for requesting the path controller to establish a data path that IP packets traverse, In this case, the mobile node sending the path establishing request message may be any one of a UE, an eNB, an AP/APC, an S-GW, an ePDG, and a P-GW.

If the path controller receives the path establishing request message in step S610, the path controller may examine whether the received path establishing request message is a message for requesting a handover in step S620.

If a result of “YES” is produced in step S620, in step S640, the path controller may acquire information on a data path used before the handover occurs, i.e., segment list, generate a data path that IP packets traverse with reference to IP addresses and port numbers of sending and receiving mobile nodes, and 5-tuple information, and transmit, to the mobile node, information on segment values of nodes corresponding to the path. In this case, the information on the segment values corresponding to the request of the handover may be the same as the segment values used before the handover occurs.

Meanwhile, if a result of “NO” is produced in step S620, i.e., if it is determined that the path establishing request message is an initial path establishing request, in step S630, the path controller may generate a data path that the IP packets traverse with reference to IP addresses and port numbers of sending and receiving mobile nodes, and 5-tuple information, and transmit, to the mobile node, information on segment values of nodes.

If the mobile node receives, from the path controller, the information on the data path that the IP packets traverse, Le., the segment values of the respective nodes, in step S650, the mobile node may add information on the segment values to the IP packet. In step S660, the mobile node may transmit, to a next node, the IP packet having new information added thereto.

The above-described embodiments of the present disclosure can be implemented in the form of a program command that can be executed through various components of a computer and recorded in a computer-readable medium. The computer-readable medium may store program commands, data files, data structures, and the like in an independent or combined form. The program command recorded in the computer-readable medium may be a command specially designed and constructed for the present disclosure or a command publicized to and used by those skilled in a computer software field. The computer-readable medium includes, for example, magnetic media such as a hard disk, a floppy disk and a magnetic tape, optical recording media such as CD-ROM and DVD, magneto-optical media such as a floptical disk, and a hardware device specially constructed to store and execute a program command, such as ROM, RAM, and flash memory. The program command includes, for example, high-level language codes that can be executed by a computer using an interpreter or the like, as well as machine language codes created by a compiler. The hardware device may be constructed to operate as one or more software modules in order to perform the processing according to the present disclosure. Likewise, the software modules may be implemented by one or more hardware devices in order to perform the processing according to the present disclosure.

According to the present disclosure, a data path through which an IP packet is to be transmitted between mobile nodes is established by considering service characteristics and statuses of the network, thereby establishing the data path at high speed.

According to the present disclosure, a data transmission path before a handover occurs is established to be used after the handover occurs, thereby reducing a delay caused by the handover.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present disclosure as set forth in the following claims.

What is claimed is:

1. A path controller for transmitting an IP packet in a mobile communication system including heterogeneous networks, the path controller comprising:
a data transmission path establishing module configured to, when a request message for establishing a data path is received from any one of a plurality of mobile nodes, determine nodes that IP packets traverse between the plurality of mobile nodes, and transmit a segment list or a set of segment list corresponding to the determined nodes that IP packets traverse to the mobile node sending the request message for establishing the data path,
wherein the plurality of mobile nodes are connected to transport nodes that enable the IP packets to traverse between the plurality of mobile nodes, a plurality of nodes that transmit the IP packets are provided between the transport nodes, and the data path is set by the determined nodes among the plurality of nodes.

2. The path controller of claim 1, further comprising a data transmission path storage module configured to acquire and store information on the nodes that the IP packets traverse, the nodes being determined by the data transmission path establishing module.

3. The path controller of claim 1, wherein the plurality of mobile nodes include mobile nodes used in a first network and mobile nodes used in a second network, and
wherein, when the mobile nodes used in the first network includes an evolved node B (eNB), a packet gateway (P-GW) and a serving gateway (S-GW) and the mobile nodes used in the second network includes an access point (AP)/access point controller (APC), the packet gateway (P-GW) and an enhanced packet data gateway (ePDG), the eNB and the AP/APC are connected to a first transport node, and the S-GW and the ePDG are connected to a second transport node, and the P-GW is connected to a third transport node.

4. The path controller of claim 3, wherein the data transmission path establishing module determines nodes that the IP packet traverse, indicating a data path from the eNB to the S-GW and a data path from the S-GW to the P-GW, through which mobile communication services are provided in the first network is equal to a data path from the AP/APC to the ePDG, and a data path from the ePDG to the P-GW respectively through which mobile communication services are provided in the second network.

5. The path controller of claim 3, wherein, when the request message for establishing the data path is generated by a handover from the first network to the second network, the data transmission path establishing module acquires information on nodes used in the first network from the data transmission path storage module, and determines the nodes used in the first network once again as nodes that the IP packets traverse in the second network.

6. The path controller of claim 1, wherein the data transmission path establishing module determines nodes that the IP packets traverse with reference to IP addresses and port numbers of sending and receiving mobile nodes, and 5-tuple information.

7. The path controller of claim 6, wherein the data transmission path establishing module determines nodes that the IP packets traverse with reference to at least one of characteristics of mobile communication services and network statuses.

8. A method for transmitting an IP packet in a mobile communication system including heterogeneous networks, the method comprising:
(a) receiving a request message for establishing a data path from any one of a plurality of mobile nodes;
(b) when the request message for establishing the data path is received, determining nodes that IP packets traverse between the plurality of mobile nodes, wherein the plurality of mobile nodes are connected to transport nodes that enable the IP packets to traverse between the plurality of mobile nodes, a plurality of nodes that transmit the IP packets are provided between the transport nodes, and the data path is set by the determined nodes among the plurality of nodes; and
(c) transmitting a segment list or set of segment lists corresponding to the determined nodes to the mobile node transmitting the request message for establishment of the data path.

9. The method of claim 8, wherein the plurality of mobile nodes include mobile nodes used in a first network and mobile nodes used in a second network, and
wherein, when the mobile nodes used in the first network includes an evolved node B (eNB), a packet gateway (P-GW) and a serving gateway (S-GW) and the mobile nodes used in the second network includes an access point (AP)/access point controller (APC), the packet gateway (P-GW) and an enhanced packet data gateway (ePDG), the eNB and the AP/APC are connected to a first transport node, and the S-GW and the ePDG are connected to a second transport node, and the P-GW is connected to a third transport node.

10. The method of claim 9, wherein, in (b), when the request message for establishing the data path is generated by a handover from the first network to the second network, the nodes used in the first network are determined as nodes through which the IP packets is to pass in the second network.

11. The method of claim 9, wherein, in (b), nodes that the IP packets traverse are determined with reference to at least one of characteristics of mobile communication services and network statuses.
